(19) United States
(12) Patent Application Publication
(10) Pub. No.: US 2005/0200645 A1
(43) Pub. Date: Sep. 15, 2005

(54) Image forming apparatus and storage medium

(75) Inventor: Makoto Kobayashi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation

(21) Appl. No.: 11/032,234

(22) Filed: Jan. 11, 2005

(30) Foreign Application Priority Data
Jan. 16, 2004 (JP) 2004-9687

(51) Int. Cl. B41J 29/393

(52) U.S. Cl. 347/19

(57) ABSTRACT

The present invention provides an image forming apparatus which is capable of eliminating the waste incurred when a storage medium such as a ROM storing a program is recreated and responding individually to each user, and a storage medium. Tables used for color conversion processing, calibration processing, and screen processing are stored in a rewritable area of a program ROM 23, which is separate from a main body block thereof in which each module of the program is stored. Table selection is performed by comparing a fixed value stored in a color conversion module (data processing portion) 234 with information relating to a paper type, a screen type, and a color matching type specified on a host computer 1. If the information is within the range of the fixed value, the address at which the table is stored is calculated, and the table is selected.

### TECHNICAL FIELD

The present invention relates to an image forming apparatus and a storage medium enabling rewriting of a program module. More specifically, the present invention relates to an image forming apparatus and a storage medium in which table data used in a color conversion module are stored in a rewritable area.

### BACKGROUND ART

Conventionally, a control program is stored in advance in a storage medium, such as a ROM (Read Only Memory) of a printing apparatus, and a CPU reads and executes the control program in order to control the entire printing apparatus. However, when a bug is discovered in the control program, the printing apparatus must be disassembled in order to exchange the ROM. Therefore, conventionally a bug correction program is stored on a ROM card, and the ROM card is installed in the printing apparatus when necessary in order to correct the control program stored in the ROM, and thereby correct the bug (see Japanese Laid-open Patent Publication H4-323070, for example).

However, when the control program is rewritten by the correction program, if the data amount in a part of the information thereof differs from the data amount of the information prior to correction, the address information must also be rewritten, and hence the entirety of the program stored in the ROM must be rewritten.

For example, in a case where a plurality of look-up tables (LUTs) is stored in the ROM when performing color conversion of image data in the printing apparatus, the size of the LUTs may change as a result of the correction, and if so, the address in the ROM of each subsequent module of the program is also modified in succession, as a result of which it may be impossible to execute the program.

Conversely, if there were no need to rewrite the other modules even when the module including information such as the LUTs is rewritten, then printing could be performed in accordance with the wishes of the user, thereby enabling individual user response.

### DISCLOSURE OF THE INVENTION

It is therefore an object of the present invention to provide an image forming apparatus which is capable of responding individually to each user by eliminating the waste incurred when a storage medium such as a ROM storing a program is recreated, and a storage medium.

To achieve this object, the present invention is an image forming apparatus in which a modularized program is stored, for forming an image on the basis of this program, comprising rewritable storage unit for storing table data required when a color conversion module of the program is to be executed, and control unit for reading the table data from the storage unit when the color conversion module is to be executed using the table data, and executing the color conversion module. Hence, when a user wishes to add to or otherwise modify the table data individually, for example, there is no need to rewrite the main body program, and therefore the waste incurred when the storage medium is recreated can be eliminated, and an image forming apparatus which is capable of responding to individual users can be provided.

Further, in the image forming apparatus of the present invention, the table data include color conversion table data for converting RGB image data into CMYK image data, and the color conversion module includes a module for performing color conversion processing through the control means using the color conversion table data. Hence there is no need to rewrite the storage medium in which the main body of the program is stored even if the user freely adds to or otherwise modifies the tables used for color conversion.

Further, in the image forming apparatus of the present invention, the table data include a calibration table for modifying an engine characteristic, and the color conversion module includes a module for performing calibration processing through the control unit using the calibration table. Hence there is no need to rewrite the storage medium in which the main body of the program is stored even if the user freely adds to or otherwise modifies the tables used for calibration processing, for example, and thus an image forming apparatus which can respond to individual users can be provided.

Further, in the image forming apparatus of the present invention, the table data include a screen table for generating dot data expressing a halftone of a grayscale image, and the color conversion module includes a module for performing screen processing through the control unit. Hence there is no need to rewrite the storage medium in which the main body of the program is stored even if the user freely adds to or otherwise modifies the screen tables, for example, and thus an image forming apparatus which can respond to individual users can be provided.

Further, in the image forming apparatus of the present invention, the storage unit is a different medium to the storage medium in which the program is stored. Hence, each process can be executed using new table data by loading only this medium into the image forming apparatus, for example.

Further, in the image forming apparatus of the present invention, the storage unit is an external storage medium that can be loaded into the image forming apparatus. Hence, the desired table data of the user can be stored in the external storage medium in advance, for example, and hence a desired image can be formed in the image forming apparatus. Thus an image forming apparatus with enhanced user-friendliness can be provided.

Further, in the image forming apparatus of the present invention, the control unit select any one of the table data from a, combination of at least two of a paper type, a color matching type, and a screen type, and execute the color conversion module on the basis of the selected table data. Hence the color conversion module is executed by selecting table data corresponding to the paper type, color matching type, and screen type, for example, and therefore an image forming apparatus which can respond to individual users can be provided.

Further, to achieve the object described above, the present invention is a storage medium for storing a modularized program, which is read by said image forming apparatus, thereby forming an image, comprising a rewritable area for storing table data required when a color conversion module of the program is to be executed, wherein when the color conversion module is to be executed in the image forming apparatus using the table data, the color conversion module is executed by reading the table data from the rewritable area. Hence there is no need to rewrite the main body program when the user wishes to add to or otherwise modify the table data individually, for example, and therefore the waste incurred when the storage medium is recreated can be eliminated, and a storage medium which is capable of responding to individual users can be provided.

### BRIEF DESCRIPTION OF THE DRAWINGS

FIG. 1 is a view showing the constitution of an image forming apparatus 2;

FIG. 2 is a view showing the constitution of a program ROM 23;

FIG. 3 is a view showing an example of a case in which a table data portion 237 is stored in an NVRAM 24;

FIG. 4 is a view showing the constitution of a color conversion module (table data portion) 237;

FIG. 5 is a schematic diagram illustrating LUT table selection;

FIG. 6(A) is a schematic diagram illustrating calibration table selection, and FIG. 6(B) is a schematic diagram illustrating screen table selection;

FIG. 7 is a flowchart showing an overall processing operation of the image forming apparatus 2;

FIG. 8 is a flowchart showing a printer activation processing operation;

FIG. 9 is a flowchart showing a module start-up processing operation;

FIG. 10 is a flowchart showing a data reception processing operation;

FIG. 11 is a flowchart showing a language processing operation;

FIG. 12 is a flowchart showing a special language activation processing operation;

FIG. 13 is a flowchart showing a color conversion processing operation;

FIG. 14 is a flowchart showing a LUT selection processing operation;

FIG. 15 is a flowchart showing a calibration table and screen table selection processing operation;

FIG. 16 is a flowchart showing a band creation processing operation;

FIG. 17 is a flowchart showing a print processing operation;

FIG. 18 is a schematic diagram illustrating LUT table selection;

FIG. 19 is a view showing another-constitution of the table data portion 237;

FIG. 20 is a flowchart showing a LUT selection processing operation;

FIG. 21 is a flowchart showing a calibration table and screen table selection processing operation;

FIG. 22 is a view showing the constitution of the color conversion module (table data portion) 237; and

FIG. 23 is a view showing another constitution of the image forming apparatus 2.

### BEST MODES FOR CARRYING OUT THE INVENTION

### First Embodiment

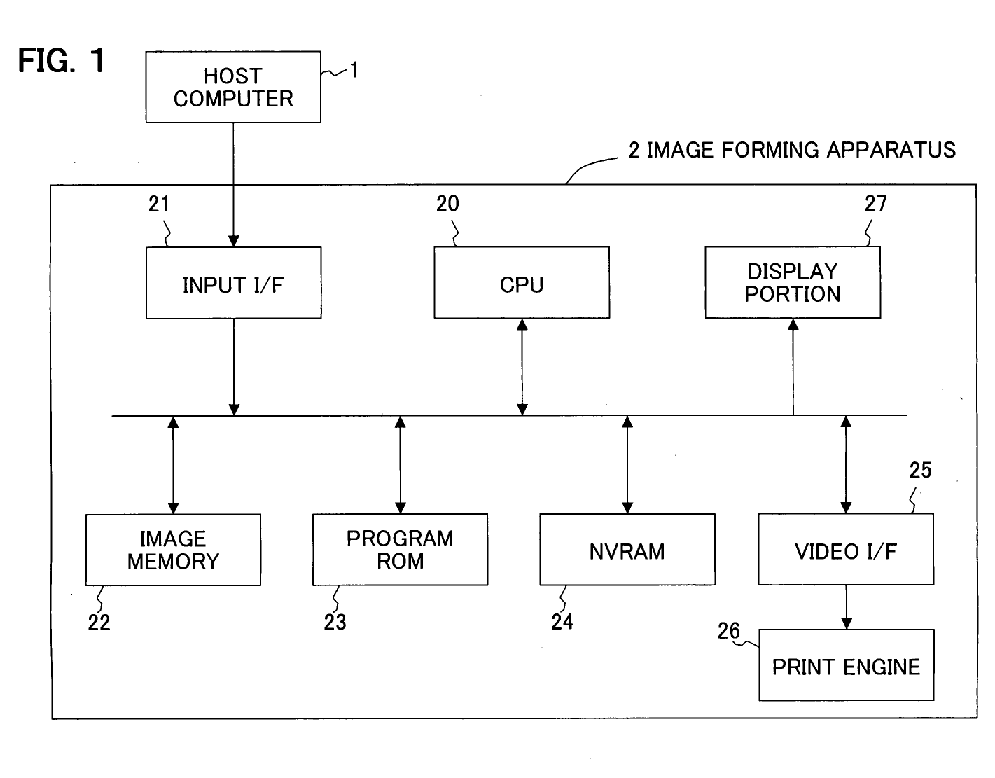

The best modes for carrying out the present invention will be described below with appropriate reference to the drawings. FIG. 1 is a view showing the overall constitution of an image forming apparatus 2 to which the present invention is applied. As shown in FIG. 1, the image forming apparatus 2 as a whole is constituted by a CPU 20, an input I/F 21, an image memory 22, a program ROM 23, an NVRAM (Nonvolatile Random Access Memory) 24, a video I/F 25, a print engine 26, and a display portion 27.

The CPU 20 is connected to the input I/F 21, image memory 22, program ROM 23, NVRAM 24, video I/F 25, and display portion 27 via a bus. The CPU 20 reads and executes a modularized program stored in the program ROM 23 such that various processes are executed in the image forming apparatus 2. This will be described in detail hereafter.

The input interface (I/F) 21 is also connected to a host computer 1. Print data are inputted into the input I/F 21 from the host 1 in a predetermined transmission format, and converted by the input I/F 21 into data that can be processed in the image forming apparatus 2.

The image memory 22 stores image data included in the print data from the input I/F 21 temporarily under the control of the CPU 20. The image memory 22 also stores color-converted image data, as will be described below. In this case, the image memory 22 functions as a band memory.

The program ROM 23 stores a program to be executed by the CPU 20. An appropriate program is read and executed by the CPU 20. In this embodiment, the program ROM 23 stores a modularized program, a part of the modules being stored in a rewritable area. This will be described in detail hereafter.

The NVRAM 24 stores initial data such as information regarding the model of the image forming apparatus 2. The initial data are read appropriately by the CPU 20. A part of the aforementioned modules is also stored therein. This will be described in detail hereafter.

The video I/F 25 is also connected to the print engine 26. The video I/F 25 reads image data from the image memory 22 under the control of the CPU 20, generates pulse data for each dot of the printed image, and outputs the pulse data to the print engine 26. More specifically, color conversion processing for converting RGB (red, green, blue) image data from the image memory 22 into CMYK (cyan, magenta, yellow, black) image data, color adjustment (calibration) processing for modifying the characteristics of each print engine 26 by correcting color differences among devices such as a display, the image forming apparatus 2, and so on in relation to the color-converted CMYK image data, screen processing for generating dot data expressing the halftone of a grayscale image in relation to the calibrated CMYK image data, and pulse width modulation processing for performing pulse width modulation on the dot data and generating pulse data for each dot, are performed.

The pulse data from the video I/F 25 are inputted into the print engine 26, whereby the print engine 26 forms an actual image on a printing medium such as printing paper. For example, a photosensitive drum charged on the basis of the pulse data is irradiated with laser light, not shown in the drawing, to form an electrostatic latent image, whereupon toner of each color is adhered to the drum and developed, and thus an image is formed by compression bonding or the like on the printing medium via an intermediate transfer belt, roller, or other device.

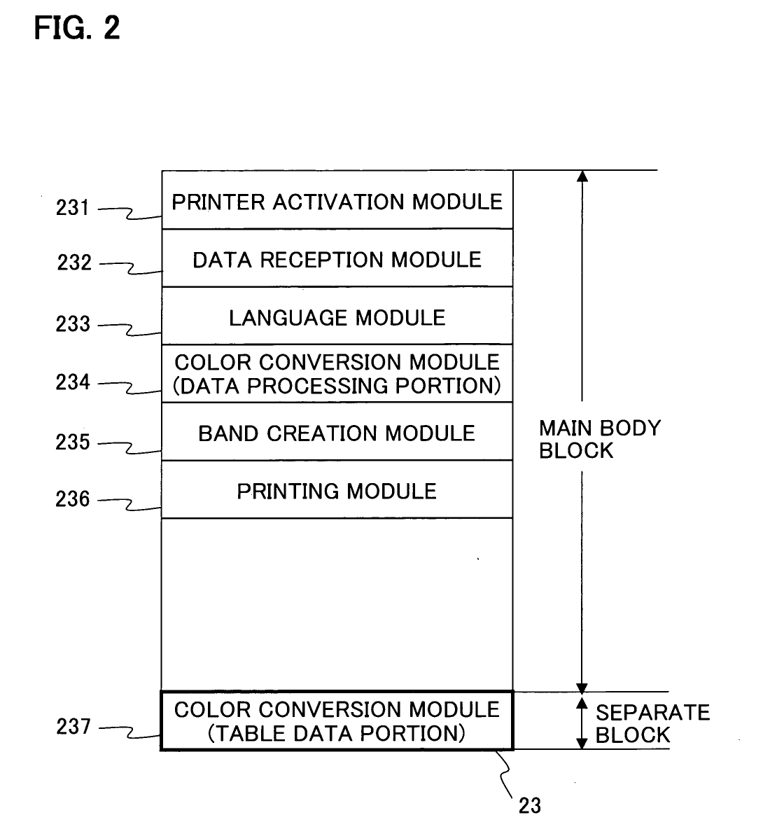

The constitution of the aforementioned program ROM 23 will now be described in detail. FIG. 2 shows an example thereof. As shown in FIG. 2, the program ROM 23 is constituted by a main body block in which a modularized program is stored, and a rewritable separate block. A printer activation module 231, a data reception module 232, a language module 233, a color conversion module (data processing portion) 234, a band creation module 235, and a printing module 236 are stored in the main body block. The modularized program is read and executed by the CPU 20, whereby various processes are executed within the image forming apparatus 2.

The printer activation module 231 is a module for performing processing related to a start-up operation of the image forming apparatus 2 following power supply. The data reception module 232 is a module for performing processing to receive print data from the host computer 1. The language module 233 is a module for interpreting the received data and so on. The color conversion module (data processing portion) 234 is a module for performing processing such as color converting RGB image data into CMYK image data in accordance with the interpreted data. The band creation module 235 is a module for performing processing to store the color-converted CMYK image data in the band memory (image memory 22). The printing module 236 is a module for reading the image data stored in the band memory and performing calibration processing and screen processing thereon, and also for performing an actual printing operation.

The present invention further comprises a color conversion module (table data portion) 237 in which various tables used for the color conversion processing, calibration processing, and screen processing are stored. As shown in FIG. 2, this color conversion module 237 is stored in the rewritable separate block. By storing the color conversion module 237 in the rewritable separate block in this manner, when a user wishes to perform printing with the addition of a table other than the pre-stored screen table, for example, a table can be added simply by rewriting the color conversion module 237 in the separate block. If this module is provided within the color conversion module 234 in the main body block, the size of the table may change upon rewriting, causing a change in the storage position of the subsequent band creation module 235 and printing module 236. If the address position of these modules is different when the modules are to be read by the CPU 20, the modules cannot be read, and hence it may be impossible to execute processing. By storing the table data in a rewritable area, individual user response and so on become possible, thereby enhancing the user-friendliness of the processing. Color conversion processing and so on are performed by having the CPU 20 read the tables stored in this area.

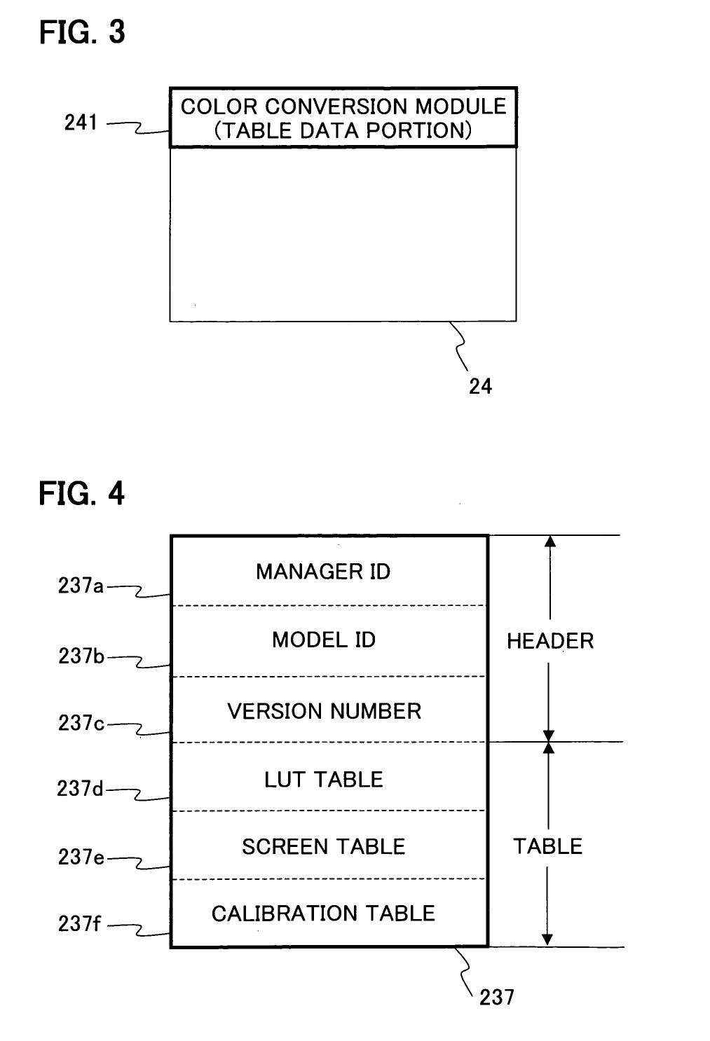

Note that the color conversion module 237 storing the table data may be stored in the NVRAM 24 in FIG. 1, for example, as well as the program ROM 23. An example thereof is shown in FIG. 3. A predetermined area 241 of the NVRAM 24 is secured in advance, and the color conversion module (table data portion) 237 used for color conversion processing and the like is stored in this area. The CPU 20 performs table selection and so on by reading the module from the NVRAM 24. The module may also be stored in storage means such as an external ROM, as will be described below.

An example of the constitution of the color conversion module (table data portion) 237 is shown in FIG. 4. The color conversion module (table data portion) 237 is constituted by a header and a table.

The header is constituted by a manager ID (identification) 237a, a model ID 237b, and a version number 237c. Identification numbers allocated in advance for differentiating between the various modules are stored in the manager ID 237a. Note that the color conversion module (data processing portion) 234 and the color conversion module (table data portion) 237 are allocated different identification numbers. Identification information relating to model information, for example information allocated to each image forming apparatus 2, is stored in the model ID 237b. A version number of the table data stored in the color conversion module (table data portion) 237 is stored in the version number 237c. As will be described below, the latest table data can be identified according to the version number 237c.

Table information required for the various processes is also stored in the table. As shown in FIG. 4, the table is constituted by a LUT table 237d, a screen table 237e, and a calibration table 237f. A look-up table (LUT) used in the color conversion processing from RGB to CMYK is stored in the LUT table 237d. A table used in the screen processing is stored in the screen table 237e. A table used in the calibration processing is stored in the calibration table 237f.

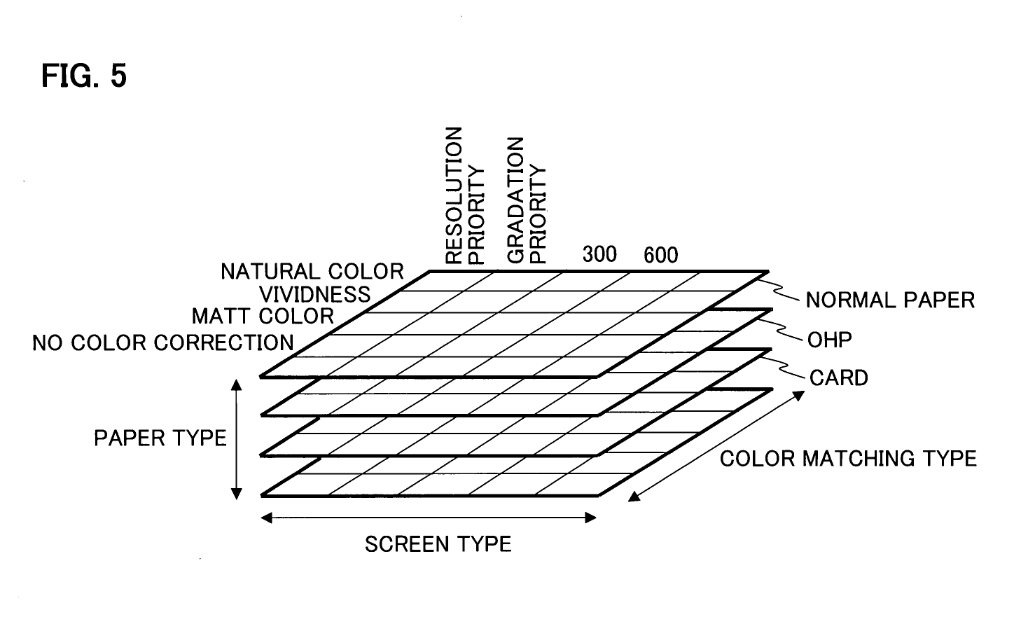

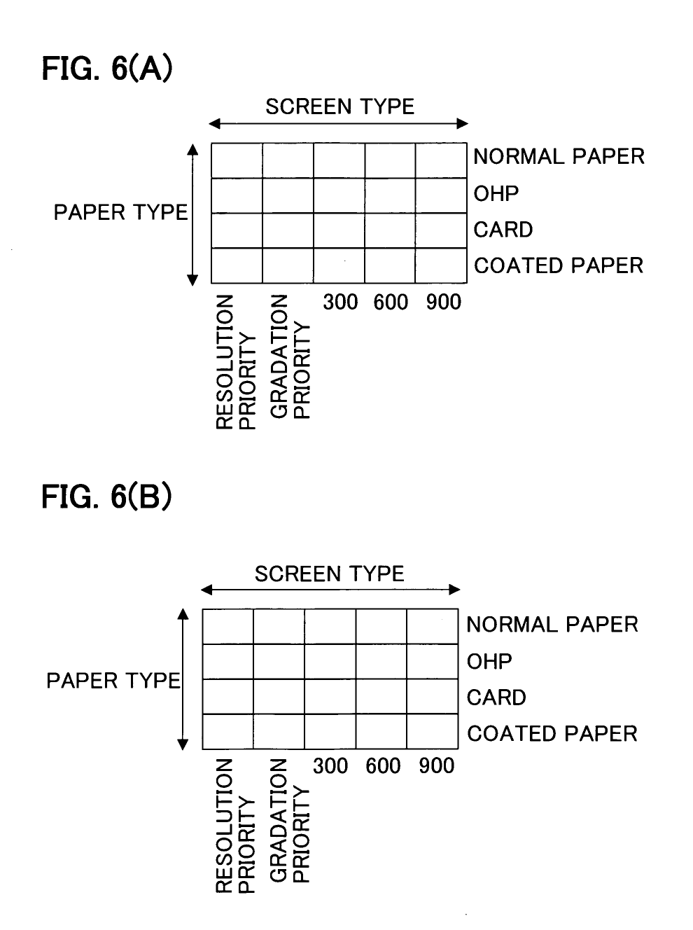

An example of the constitution of each table is shown in FIGS. 5 and 6. FIG. 5 shows an example of the constitution of the LUT table 237d. The LUT table 237d is constituted by a plurality of tables, whereby one table is selected on the basis of three types of information (parameters) comprising paper type, color matching type, and screen type. The paper type comprises normal paper, OHP, card, coated paper, and so on, for example. The color matching type comprises a case in which natural colors are to be emphasized on the printed image, a case in which vividness is to be emphasized, a case in which the printed image is to be realized using matt colors, a case in which color correction is not to be performed, and so on. The screen type comprises prioritizing resolution, prioritizing gradation, a screen for a resolution of 300 dpi, a screen for a resolution of 600 dpi, and so on. A single LUT table is selected from these three parameters. Note that the parameters are set on the host computer 1 (more specifically, by a driver installed in the host computer 1), and inputted into the image forming apparatus 2 as print data. The color conversion module 234 is read by the CPU 20 in order to execute color conversion processing, and the LUT table 237d stored in the color conversion module (table data portion) 237 is selected during this processing.

Examples of the constitution of the calibration table 237f and screen table 237e stored in the table data portion 237 are shown in FIGS. 6(A) and 6(B) respectively. In both cases, a single table is selected according to the paper type and screen type. These table selections are also performed in the color conversion processing to be described below in accordance with information relating to the screen type and information relating to the paper type from the host computer 1.

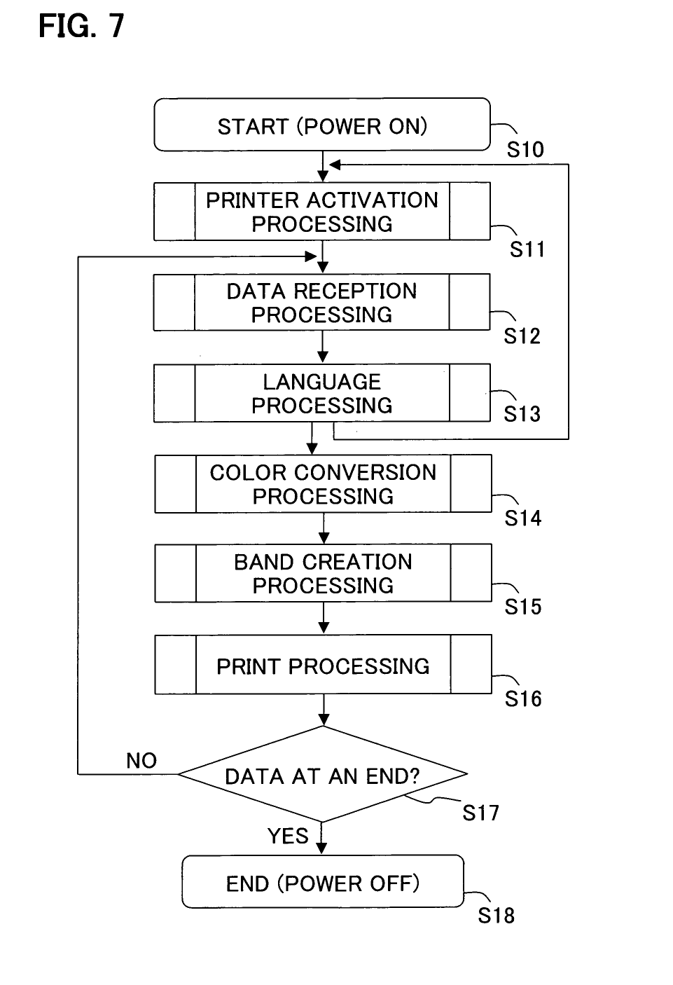

Next, an operation performed in the image forming apparatus 2 constituted as described above will be described in detail. FIG. 7 is a flowchart showing an overall processing operation performed by reading the program (see FIG. 2) stored in the program ROM 23.

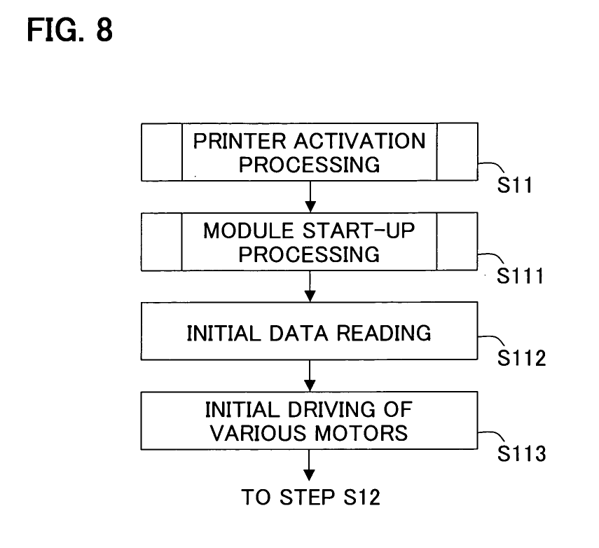

First, power is supplied to the image forming apparatus 2, whereupon the CPU 20 begins the processing by reading out the program stored in the program ROM 23 (step S10). Next, the CPU 20 initiates printer activation processing by the printer activation module 231 (step S11). This printer activation processing is illustrated in detail in FIG. 8.

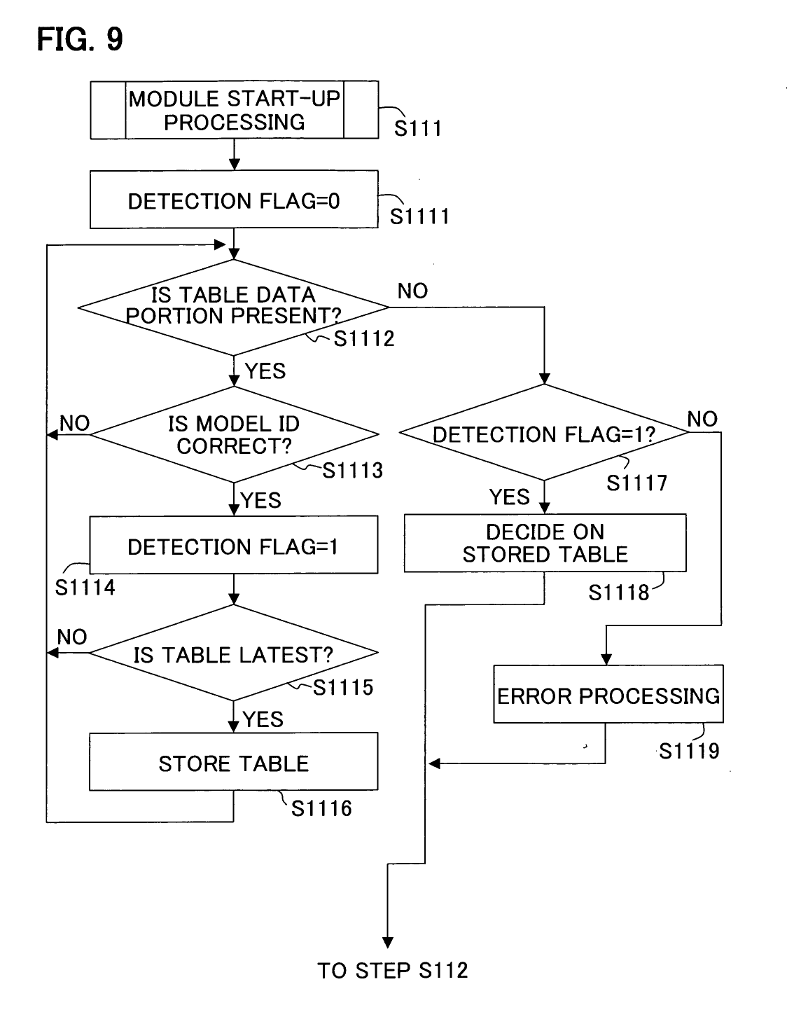

First, the CPU 20 performs module start-up processing (step S11). In this module start-up processing, the modules of the program read out from the program ROM 23 are configured into a list configuration in order to grasp the relationships among the modules. Processing is also performed to decide on the stored table data portion 237 by checking whether the table data portion 237 has been updated to the latest version. This module start-up processing is illustrated in detail in FIG. 9.

When the CPU 20 advances to the module start-up processing (step S111), the modules are reconfigured, and then a detection flag is set to “0” (step S1111). The detection flag indicates whether or not the table data portion 237 has been located. At this stage, the CPU 20 has not been able to locate the table data portion 237, and therefore the detection flag is set at “0”. The CPU 20 performs this setting by storing “0” in a predetermined area of a working memory, not shown in the drawings, for example.

Next, the CPU 20 determines whether or not the table data portion 237 is present (step S1112). The CPU 20 determines whether table data have been written by accessing the rewritable area (the separate block in FIG. 2) of the program ROM 23 or the NVRAM 24. If table data have been stored in the table data portion 237 (“YES” in this step), the process advances to a step S1113, and if not (“NO” in this step), the process advances to a step S1117.

In the step S1113, the CPU 20 determines whether or not the model ID is correct. The CPU 20 extracts the model ID 237b (see FIG. 4) stored in the table data portion 237, compares it with model information described in advance in the printer activation module 231, and determines whether or not the model ID 237b and model information match. If so (“YES” in this step), the processing advances to a step S1114, and if not, the process returns to the step S1112, where the processing described above is repeated.

In the step S1114, the CPU 20 sets the detection flag to “1”. When the table data portion 237 has been located and the model ID matches the model information, the table data portion 237 may be used in the image forming apparatus 2, and hence the flag is set to “1” at this stage. The CPU 20 performs this setting by rewriting the “0”, which was stored in the non-illustrated working memory in the step S1111, to “1”.

Next, the CPU 20 determines whether or not the located table data portion 237 is the latest version thereof (step S1115). This is performed by reading the version number 237c (see FIG. 4) of the table data portion 237 from the program ROM 23 (or NVRAM 24). More specifically, the previously-read version number 237c is stored in advance in the working memory (not shown), for example, and compared with the version number read out at this stage. If the current version number is smaller (or larger), it may be determined that the version is new, or in other words that the table data are the latest. When it is determined that the table data portion 237 is not the latest version (“NO” in this step), the process returns to the step S1112, where the processing described above is repeated.

When it is determined that the table data portion 237 is the latest version (“YES” in the step S1115), the CPU 20 then stores this latest table data portion 237 (step S1116). More specifically, the starting address for storing the table data portion 237 determined as the latest version is stored in the working memory (not shown), for example.

Next, the CPU 20 returns to the step S1112 to determine whether or not another table data portion 237 is present. If another table data portion 237 is present (“YES” in the step S1112), the processing described above is repeated.

When there is no table data portion 237 from the beginning or when there is no other table data portion 237 after the step S1116, “NO” is selected in the step S1112, whereupon the process advances to the step S1117.

In the step S1117, the CPU 20 determines whether or not the detection flag is at “1”. For example, the CPU 20 accesses the non-illustrated working memory to determine whether or not “1” is stored therein. When “1” is stored (“YES” in this step), the process advances to a step S1118, where the stored table data 237 are selected. More specifically, the starting address of the table data 237 stored in the step S1116 is set as the address destination of the table data portion 237 thereafter. Thereafter, the CPU 20 is able to read the table data portion 237 by accessing this address. On the other hand, when “1” is not stored (“NO” in the step S1117), the CPU 20 performs error processing. For example, the CPU 20 performs processing such as displaying a message on the display portion 27 indicating that the table is not present. When the processing of the steps S1118 and S1119 is complete, module start-up processing ends, and the process advances to a step S112 in FIG. 8.

In the step S112, the CPU 20 performs initial data reading. For example, various setting data stored in the NVRAM 24 are read. Next, the CPU 20 performs initial driving of various motors (step S113). For example, when the print engine 26 is charged with toner, a motor is driven to shift the toner container from an insertion position to a home position. The printer activation processing (step S11) performed by the printer activation module 231 then ends.

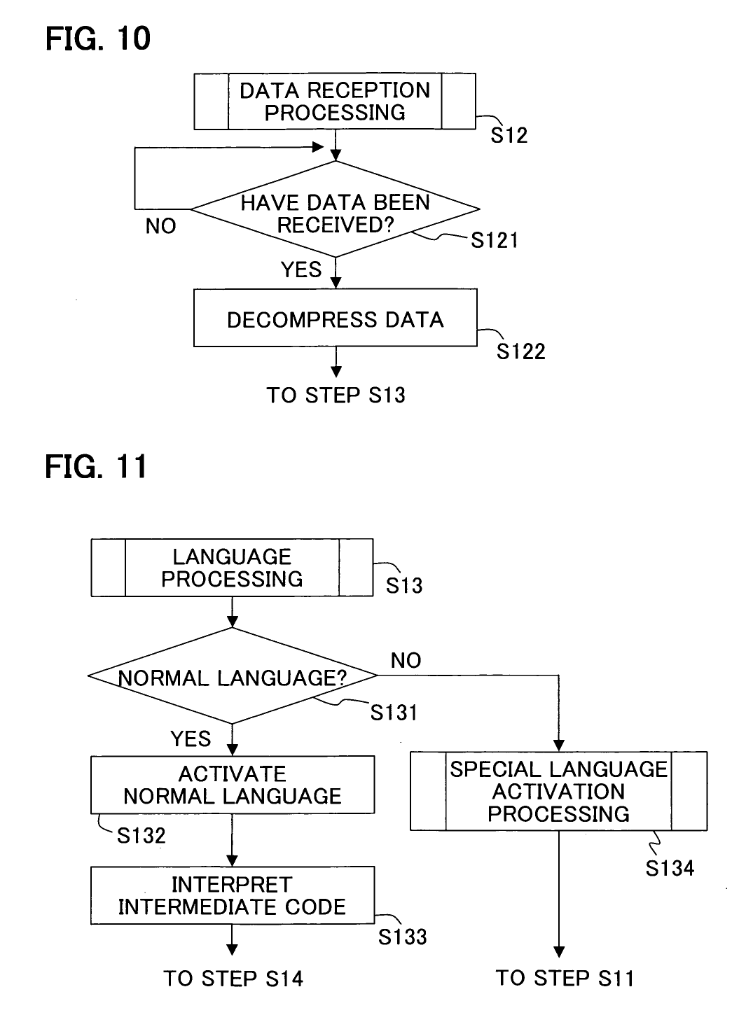

Returning to FIG. 7, next the CPU 20 performs data reception processing (step S12) by executing the data reception module 232. This data reception processing is illustrated in detail in FIG. 10.

Having advanced to the data reception processing, the CPU 20 determines whether or not print data have been received (step S121). For example, if print data have been inputted into the input I/F 21, a control signal indicating that the print data have been inputted is outputted to the CPU 20. The CPU 20 is able to determine whether or not print data have been received according to this control signal. The process does not advance to the next step until print data are received (when a determination of “NO” is made in this step).

Having received the print data (“YES” in the step S121), the CPU 20 then performs data decompression processing (step S122). Data compression (for example, Huffman coding or the like) is performed in consideration of the data transfer efficiency when a print image is created in the host computer 1 and outputted to the image forming apparatus 2. Expansion processing is performed in the image processing apparatus 2 to transform the compressed data into pre-compression print data. Once the data have been expanded, the data reception processing (step S12) performed by the data reception module 232 ends, and the process advances to a step S13.

Returning to FIG. 7, next the CPU 20 performs language processing (step S13). Language processing is performed by the language module 233. FIG. 11 shows this language processing in detail. First, having advanced to this processing, the CPU 20 determines whether or not the language is a normal language (step S131). Typically, in the host computer 1, when an image to be printed is created, the image data thereof are expressed in a description language corresponding to a command format such as PDL (Page Description Language) or GDI (Graphic Device Interface) by a driver application program. Data indicating whether the data are described in a normal language or a special language are then added to the print data, whereupon the data are outputted to the image forming apparatus 2 in print job units. The CPU 20 makes the determination in the step S131 by reading the data indicating a normal language or a special language included in the print data. Note that the information relating to the parameters, i.e. paper type, color matching type, and screen type, used to determine the aforementioned LUT table and so on is also decided on the host computer 1 side and included in the print data.

When the print data are described in a normal language (“YES” in the step S131), the CPU 20 then activates the normal language (step S132), and interprets an intermediate code (step S133). Of the print data inputted into the image forming apparatus 2, the image data are described in a language such as the aforementioned GDI. By converting these data into an intermediate code, the actual position of the data when performing printing onto a printing medium is determined. By means of this intermediate code, the image data are expanded into the band memory. The step S133 further includes processing to generate the intermediate code. By interpreting the intermediate code, the manner in which the print data are to be expanded into the band memory can be determined, and the information regarding the paper type, color matching type, and screen type, set by the host computer 1, can be read.

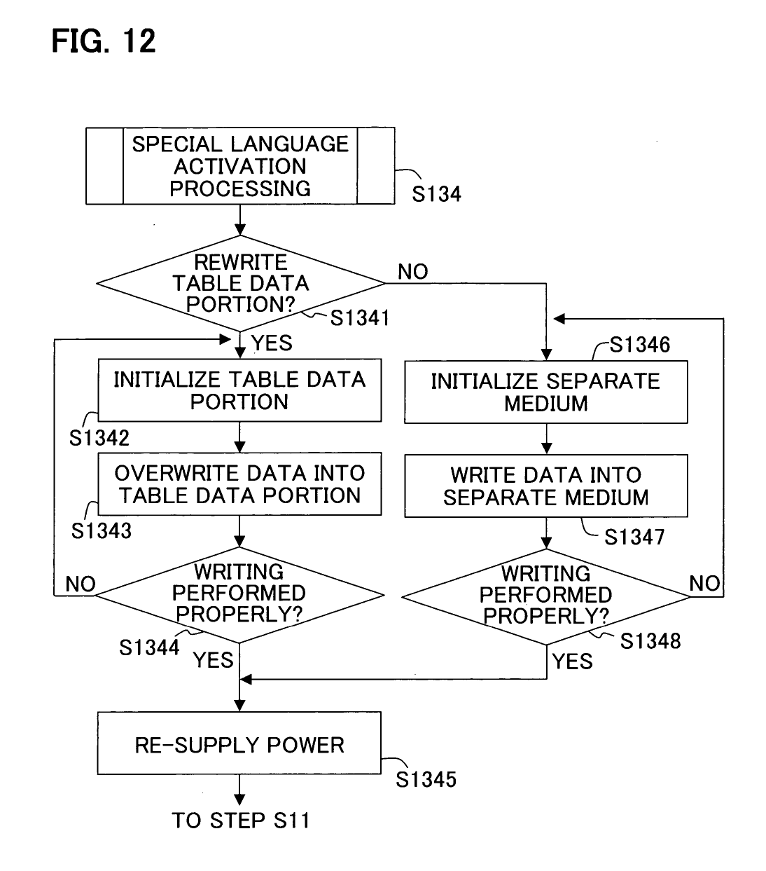

On the other hand, when the print data are described in a special language (“NO” in the step S131), the process advances to special language activation processing (step S134). This special language activation processing (step S134) is illustrated in detail in FIG. 12.

Having advanced to this processing, the CPU 20 first determines whether or not to rewrite the table data (step S1341). When data indicating the presence of data described in the special language are included in the print data outputted from the host 1 in print job units, information indicating whether to rewrite the main body firm (the program stored in the main body block of the program ROM 23) or to rewrite the option ROM is also included therein. When information indicating that the main body firm is to be rewritten is included, the CPU 20 selects “YES” in the step S1341, and when information indicating that the option ROM is to be rewritten is included, the CPU 20 selects “NO” in the step S1341.

When rewriting the table data portion 237 (“YES” in the step S1341), the main body firm must be rewritten, and therefore the table data portion 237 of the program ROM 23 is also rewritten. In order to perform this rewriting, first the CPU 20 performs initialization of the table data portion 237 (step S1342), and then performs overwrite processing on the table data portion 237 (step S1343). The table data portion 237 stored in the program ROM 23 is read out once by the CPU 20, converted into the special language, and then overwritten into the same position. If the table data portion 237 of the program ROM 23 is not written properly (“NO” in a step S1344), the process returns to the step S1342 and repeats the processing until writing is performed properly. Once writing has been performed properly (“YES” in the step S1344), the CPU 20 re-supplies power (step S1345) Thereafter, processing is performed with the overwritten table data portion 237.

On the other hand, if information indicating that the option ROM is to be rewritten is included in the print data (“NO” in the step S1341), the CPU 20 performs initialization on a rewritable separate medium in order to store the table data portion 237 in this separate medium (step S1346). The separate medium may be the NVRAM 24 in FIG. 1 or a storage medium provided on the exterior of the image forming apparatus 2, for example. Next, the CPU 20 performs processing to write the special language table data portion 237 into the separate medium (step S1347). This is performed by converting the table data portion 237, readout from the program ROM 23 in advance, into the special language, and writing the table data portion 237 into the separate medium. This process is repeated until the table data portion 237 is written properly (when “NO” is selected in a step S1348, the process returns to the step S1346) When writing has been completed properly (“YES” in the step S1348), the CPU 20 re-supplies power (step S1345). As a result, the special language processing (step S134) ends, as does language processing (see FIG. 11), and the process advances to the printer activation processing (step S11) shown in FIG. 7.

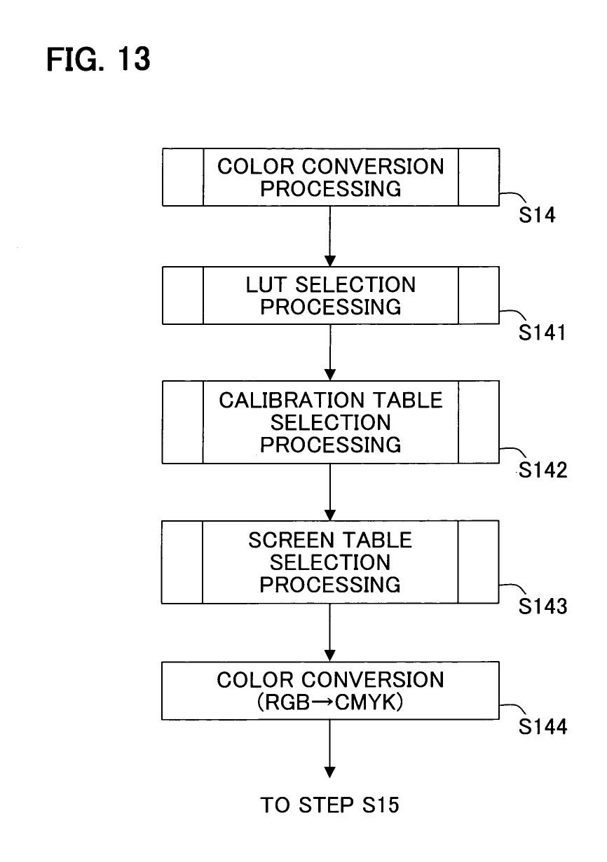

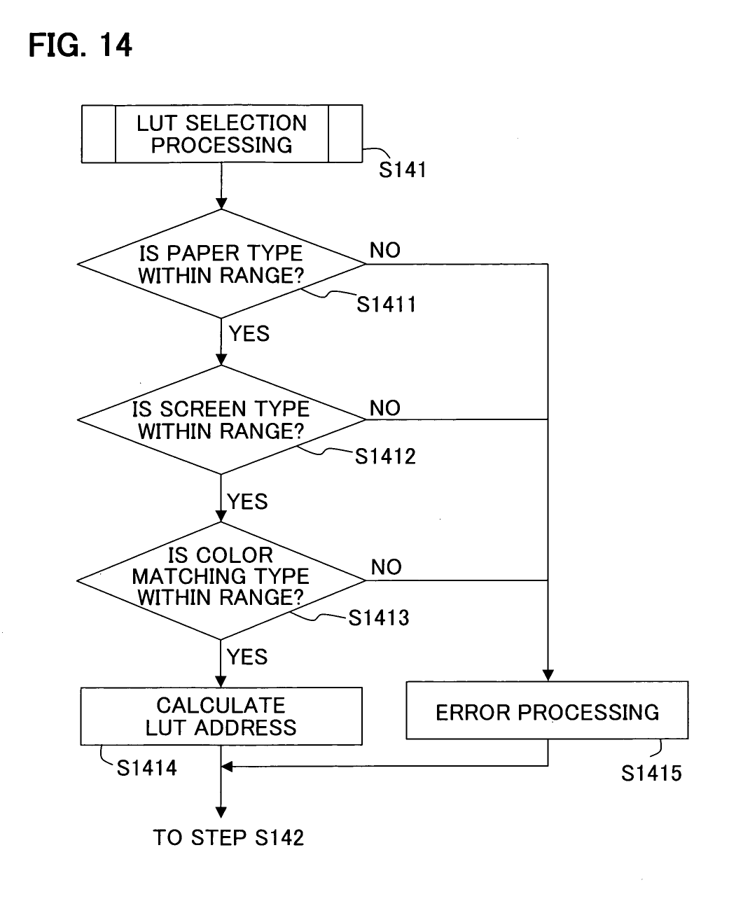

When interpretation of the intermediate code ends in the language processing shown in FIG. 11, language processing (step S13) also ends, and the process then advances to the color conversion processing (step S14) of FIG. 7. This processing is performed by having the CPU 20 execute the color conversion module (data processing portion) 234 of the program ROM 23. A flowchart showing a color conversion processing operation is depicted in FIG. 13. Having advanced to the color conversion processing (step S14), first the CPU 20 performs LUT selection processing (step S141). In this processing, one of the plurality of LUT tables stored in the LUT table 237d (see FIG. 4) of the table data portion 237 is selected. This LUT selection processing (step S141) is shown in detail in FIG. 14.

In the LUT selection processing, first the CPU 20 determines whether or not the paper type is within range (step S1411). As shown in FIG. 5, the paper type serves as one of the parameters for selecting the LUT table. In the LUT table 237d stored in the table data portion 237, the number of paper types for selection is defined as a fixed value. In the case of FIG. 5, for example, four paper types (normal paper, OHP, card, and coated paper) are defined. For example, this number of paper types is stored in the color conversion module (data processing portion) 234 as a fixed value, and in the step S1411, the CPU 20 first reads this value. Then, during interpretation of the intermediate code (step S133) in the language processing (step S13, see FIG. 11), the CPU 20 extracts the paper type information included in the print data from the host 1 side, and stores the information in the working memory, not shown in the drawings, for example. The CPU 20 reads the paper type information from the working memory in the step S1411, and compares the information with the fixed value in the color conversion module (data processing portion) 234 to determine whether or not the paper type is within range. In the example in FIG. 5, for example, “4” is stored in the color conversion module (data processing portion) 234 as the fixed paper type value. Hence, if “3” (=card) is stored in the working memory as the paper type information as a result of interpretation of the intermediate code (step S133), it is determined in the step S1411 that the paper type is within the range of the fixed value (“YES”). If, on the other hand, the paper type information determined during interpretation of the intermediate code is “5” (glossy paper, for example), this exceeds the fixed value of “4”, and it is therefore determined that the paper type is out of range (“NO” in the step S1411).

When it is determined that the paper type is within range (“YES” in the step S1411), the CPU 20 then determines whether or not the screen type is within range (step S1412) Similarly to the paper type determination, a value corresponding to the number of screen types in the LUT table 237d is stored in the data conversion module (data processing portion) 234 as a fixed value. The screen type from the host 1, stored in the working memory during interpretation of the intermediate code (step S133), is read in the step S1412 and compared to the fixed value to determine whether or not the screen type is within range. In the example in FIG. 5, for example, the fixed value is “5” (since there are five screen types), and hence if “2” (=prioritizing gradation) is selected as the screen type in the print data, the screen type is within the range of the fixed value, and therefore “YES” is selected in the step S1412. If “6” (a screen for a resolution of 1200 dpi, for example) is included in the print data, then this is out of the fixed value range, and therefore “NO” is selected in the step S1412.

When the screen type is within range (“YES” in the step S1412), the CPU 20 then determines whether or not the color matching type is within the range of a fixed value (step S1413). Similarly to the step S1411 and so on, this determination is made by storing the fixed value in the color conversion module (data processing portion) 234, and then reading the color matching type information included in the print data, which is stored in the working memory during interpretation of the intermediate code (step S133), and comparing the color matching type information with the fixed value. In the example in FIG. 5, the fixed value is “5”, and hence if “2” (=emphasizing vividness) is included in the print data, it is determined that the color matching type information is within range (“YES” in the step S1413). If not, a determination of “NO” is made in the step S1413.

If the color matching type is also determined to be within range (“YES” in the step S1413), the CPU 20 then performs LUT address calculation (step S1414). Since the three parameters from the host 1 exist within the fixed values of the color conversion module (data processing portion) 234, or in other words since one of the LUT tables 237d of the table data portion 237 can be selected, the desired LUT table 237d is selected from the print data. The reason for performing address calculation is that each square of the LUT table 237d shown in FIG. 5 stores an address value at which the LUT table for selection exists, rather than the LUT table itself. In actuality, identical address values may be included in large numbers in the same square, and hence the same LUT table may be selected. If the LUT tables themselves are placed individually in all of the squares, the data amount increases, and hence by storing address values, the data amount is reduced, thus avoiding increases in the memory capacity.

The actual address calculation uses the following equation.
LUT address=paper size×(maximum screen number×maximum color matching number)+color matching type×(maximum screen number)+number of screens (1)

A single LUT table is selected using this equation. Note that the equation itself is stored in the color conversion module (data processing portion) 234, and read and executed by the CPU 20 as needed in this step to obtain an address value. The calculated address value is stored in the working memory, not shown in the drawings, by the CPU 20, for example, and read out as needed in the color conversion processing to be described below in order to perform color conversion processing.

If, on the other hand, the paper type number, screen number, and color matching number included in the print data are not within the range of their fixed values (“NO” in the steps S1411, S1412, and S1413), all processing advances to a step S1415, where the CPU 20 performs error processing. For example, the CPU 20 displays a message on the display portion 27 indicating that a LUT table could not be selected, or selects a preset LUT table as a default.

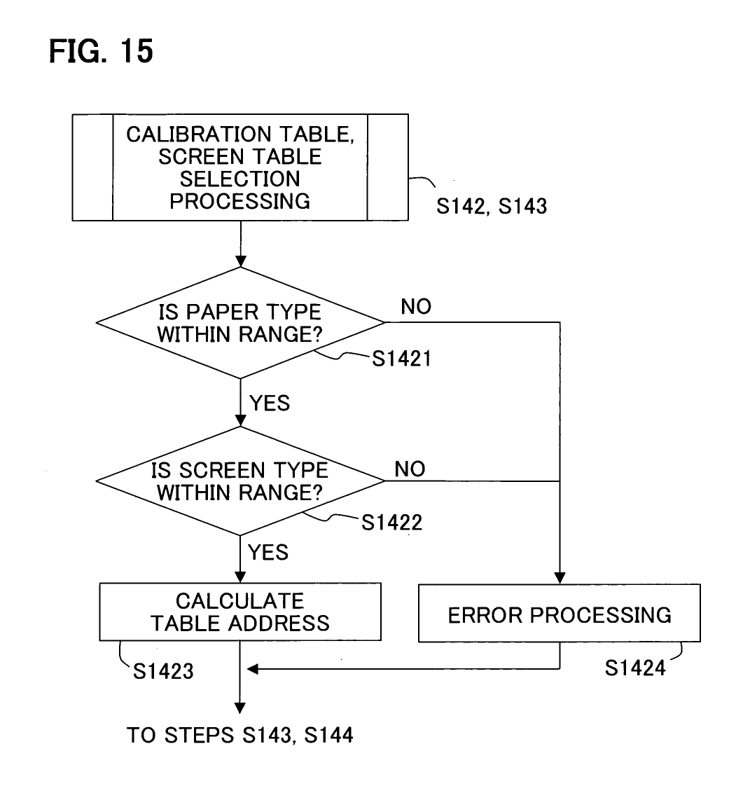

Returning to FIG. 13, when the LUT selection processing (step S141) ends, the CPU 20 then performs calibration table selection processing (step S142). This is shown in detail in FIG. 15. First, having advanced to this selection processing, the CPU 20 determines whether or not the paper type is within the range of the fixed value (step S1421). This is determined similarly to the LUT selection processing (step S141, see FIG. 14) from the fixed paper type value stored in the data processing portion 234 and the information (information included in the print data) indicating the paper type obtained in the language processing (step S13, see FIG. 11) performed by the language module 233.

If the paper type is within the range of the fixed value (“YES” in the step S1421), next the CPU 20 determines whether or not the screen type is within the range of the fixed value (step S1422). This is also determined similarly to the LUT selection processing from the fixed screen type number value stored in the data processing portion 234 and the information (likewise, information included in the print data) indicating the screen type, obtained in the language processing.

If the screen type is also within the range of the fixed value (“YES” in the step S1422), the CPU 20 then calculates a table address (step S1423). An example of the calibration table is shown in FIG. 6(A), and in this matrix, any one table is selected from the paper type information and screen type number information obtained from the language module 233. Similarly to the LUT table 237d, each square of the matrix in FIG. 6(A) actually stores an address value at which the table is stored rather than the table itself. To calculate the address, the following equation is used, whereupon the table is selected in the step S1423.
Calibration table address=paper type×(maximum screen number)+screen type (2)

It goes without saying that various address calculation methods may be considered, and the address may be determined by another calculation. Note that similarly to Equation (1), this equation is stored in the color conversion module (data processing portion) 234 and read by the CPU 20 to perform the calculation. The calculated address value is stored in the working memory, not shown, for example, and read during the calibration processing to be described below.

On the other hand, when the paper type included in the print data is outside the fixed value range (“NO” in the step S1421) or the screen type is out of range (“NO” in the step S1422), the CPU 20 performs error processing (step S1424) in both cases. Error processing consists of control to cause the CPU 20 to display a message on the display portion 27 indicating that the paper type or screen type is out of range, or selecting a default calibration table, for example.

When the table address calculation (step S1423) and error processing (step S1424) are complete, the calibration table selection processing (step S142) ends, and the process advances to screen table selection processing (step S143) shown in FIG. 13.

Screen table selection processing is also shown in detail in FIG. 15. The content of the processing is similar to that of the calibration table selection processing (step S142). In other words, if the paper type information and screen type information obtained from the language module 233 and included in the print data are within the range of the respective fixed values stored in the data processing portion 234 (“YES” in the steps S1421 and S1422), table address calculation is performed (step S1423). Similarly to the calibration table, the screen table is designed such that in the table data portion 237, a single screen table can be selected from the paper type and screen type (see FIG. 6(B), for example). By calculating the address value, the screen table stored at the corresponding address can be read. If, on the other hand, the paper type and screen type are out of range (“NO” in the steps S1421 and S1422), the CPU 20 performs error processing to select a default screen table, display an error message, or similar (step S1424). When the steps S1423 and S1424 are complete, the screen table selection processing (step S143) ends. Note that these table selection processes (steps S141 through S143) may be performed in any order.

Returning to FIG. 13, next the CPU 20 performs color conversion processing (step S144). The CPU 20 reads the LUT table selected during the LUT selection processing (step S141) from the table data portion 237 of the program ROM 23, and performs color conversion processing on the image data. In actuality, the image data included in the print data from the host computer 1 comprise an RGB gradation value for each pixel, and by means of the color conversion performed in this step, the image data are converted into data comprising CMYK gradation values which can be processed in the image forming apparatus 2. The LUT table is constituted as a table having a CMYK gradation value as an output value relating to an RGB gradation value as an input value. When the color conversion processing (step S14) is complete, the process advances to band creation processing shown in FIG. 7 (step S15).

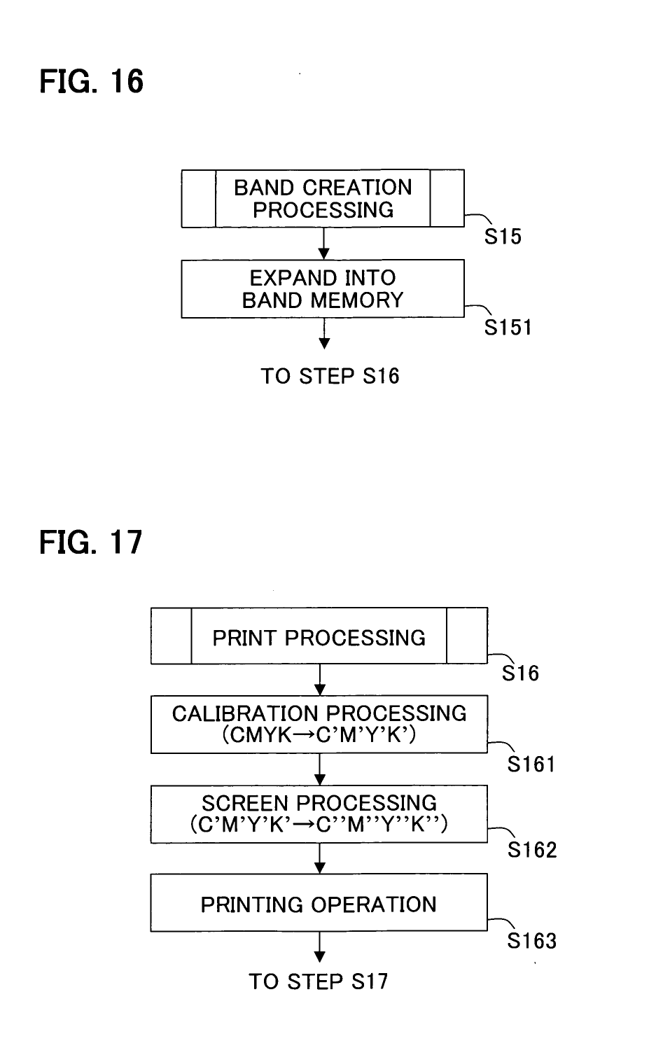

In the band creation processing (step S15), processing is performed to expand the CMYK image data into band memory having a predetermined bandwidth. This processing is performed by the band creation module 235. Each coordinate position on the band memory corresponds to a print position on the actual printing medium, and hence by means of this expansion, the image is positioned on the printing medium. Band creation processing is shown in detail in FIG. 16. Having advanced to this processing, the CPU 20 performs expansion into the band memory (step S151). The CPU 20 expands the CMYK image data that were color-converted in the color conversion processing (step S144, see FIG. 13) into a predetermined area of the image memory 22. The expansion method is described in the intermediate code, and hence expansion is performed on the basis of the interpreted intermediate code (step S133, see FIG. 11). Once expansion into the band memory has been performed, the band creation processing ends, and the process advances to print processing shown in FIG. 7 (step S16).

Print processing (step S16) consists of reading the image data expanded into the band memory, calibration processing, screen processing, and an actual printing operation. This print processing is illustrated in detail in FIG. 17. Having advanced to the print processing, the CPU 20 first performs calibration processing (step S161) As described above, calibration processing is color adjustment processing to modify the characteristics of each print engine 26 by correcting color differences among devices such as a display and the image forming apparatus 2. Each pixel comprises a predetermined gradation value, and color adjustment is performed by obtaining an output gradation value corresponding to an input gradation value using a calibration table. The calibration table used in this processing is determined by the address calculation of the step S143, and hence at this stage the address value is read out from the working memory, for example, to perform the processing. More specifically, the CPU 20 reads the calibration table selected in the step S142 from the table data portion 237 of the program ROM 23, reads the CMYK image data from the band memory (image memory 22), outputs the CMYK image data to the video I/F 25, and thus initiates the processing.

Next, the CPU 20 performs screen processing (step S162). As described above, screen processing is processing to generate dot data expressing the halftone of a grayscale image. The screen table selected in the screen table selection processing (step S143) is used to generate dot data, which are the output value of the screen table, for the calibrated CMYK image data. More specifically, the CPU 20 reads the screen table selected in the step S143 from the table data portion 237 of the program ROM 23, and initiates processing on the calibration-processed CMYK image data by the video I/F 25.

Next, the CPU 20 performs a printing operation (step S163). In this embodiment, the video I/F 25 is actually caused to perform pulse width modulation processing on the screen-processed dot data such that pulse data are generated for each dot. The generated pulse data are outputted to the print engine 26, and in the print engine 26, the aforementioned printing operation is performed by irradiating a photosensitive drum with laser light based on the pulse data.

Returning to FIG. 7, when the print processing is complete, the CPU 20 then determines whether or not the print data are at an end (step S17). If so, (“YES” in this step), the power of the image forming apparatus 2 is switched off, and the series of processes ends. If further print data have been inputted into the image forming apparatus 2 (“NO” in this step), the process advances to the step S12, where the processing described above is repeated.

As described above, in the present invention the table data that are used in the color conversion processing, calibration processing, and screen processing are stored in a rewritable area of the color conversion module, and hence when an addition is to be made to the pre-stored tables, there is no need to rewrite the modules stored in the main body block. As a result, the image forming apparatus 2 can be used even when a user adds a table subsequently, for example. Further, the latest table can be extracted and used in the activation processing (step S111, see FIG. 9) of the image forming apparatus 2, and hence subsequent color conversion processing and the like can be performed using an added table, for example.

### Second Embodiment

In the embodiment described above, tables are stored in the table data portion 237 of the program ROM 23 in addition to the header, but in this embodiment, a maximum paper type number, maximum screen type number, and maximum color matching type number are also stored therein.

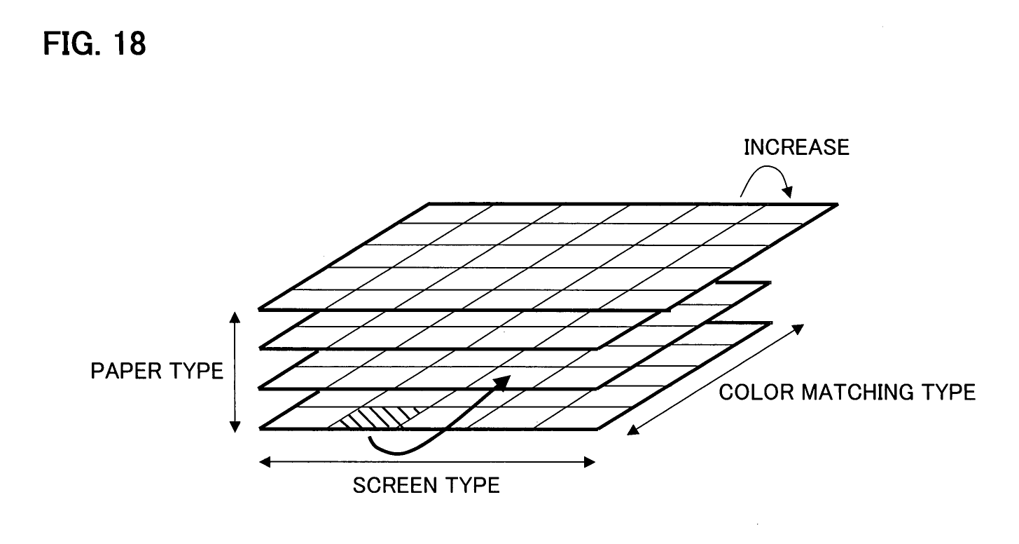

As described above, in the LUT table 237d used in the RGB to CMYK color conversion processing, a single LUT table 237d is selected from three parameters, i.e. paper type, color matching type, and screen type. Here, when one of the selection parameters of the LUT table 237d stored in advance in the table data portion 237, for example the screen type, is increased due to rewriting of the table data portion 237, as shown in FIG. 18, the screen type deviates if address calculation is performed similarly to that performed previously, and hence the LUT table 237d that would have been selected originally can no longer be selected. If the LUT table shown by the diagonal shading in FIG. 18 would have been selected prior to the increase, and an attempt is made to select the same diagonally-shaded LUT table after the increase in screen types, the table shown by the arrow in the drawing is selected due to the increase in the number of tables. In other words, the data structure of the table data portion 237 is a two-dimensional structure rather than the three-dimensional structure shown in FIG. 18, and therefore if the number of tables is increased at a midway point, the positions of the following tables deviate. As a result of this deviation, the modules stored in the program ROM 23 must be recreated, which is wastefully laborious.

To prevent this position deviation caused by an increase in the number of tables due to the rewriting of a table, a maximum parameter value is stored in the rewritable area in advance such that if a parameter within the range is specified, processing is performed, and if not, error processing is performed. In so doing, demands for individual user response and the like can be answered, and if the maximum value is also displayed on the display portion 27 and transmitted to the host computer 1 side for display thereon, the user can specify a parameter within that range, thereby enhancing user-friendliness.

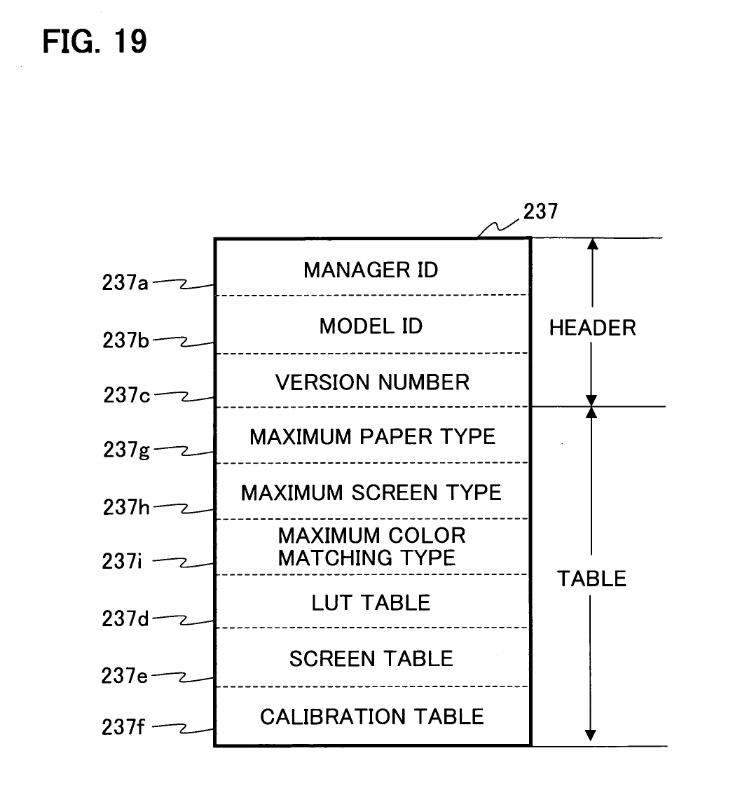

This will now be described in detail. FIG. 19 is a view showing the constitution of the table data portion 237 of the program ROM 23. In addition to the constitution shown in FIG. 4, a maximum paper type 237g, a maximum screen type 237h, and a maximum color matching type 237i can be stored. By enabling these maximum values of the three parameters to be stored in the rewritable area, the LUT types, calibration types, and screen types can be increased for each user, which is convenient for enabling individual user response.

Next, processing operations of the image forming apparatus 2 when these maximum values are stored will be described. The series of operations is substantially identical to that shown in FIG. 7. More specifically, first power is supplied, whereupon processing is begun by having the CPU 20 read the program (see FIG. 2) stored in the main body block of the program ROM 23 (step S10). Next, printer activation processing (step S11) is performed by the printer activation module 231, and the latest table data stored in the table data portion 237 are determined during module start-up processing (step S111, see FIGS. 8, 9).

Next, the CPU 20 performs data reception processing (step S12) through the data reception module 232, whereby print data are received from the host 1. Next, the CPU 20 performs language processing (step S13) through the language module 233, whereby print data expressed in GDI or the like are converted into an intermediate code and the intermediate code is interpreted. Information about the paper type, color matching type, and screen type (for example, the paper type is normal paper (“1”), the color matching type is natural color (“1”), and the screen type is gradation priority (“2”)), which is specified on the host 1 side, is also obtained by this processing. In the case of a special language, overwrite processing or the like is performed on the table data 237, whereupon the process returns to the step S11 to re-supply power, and the processing described above is repeated.

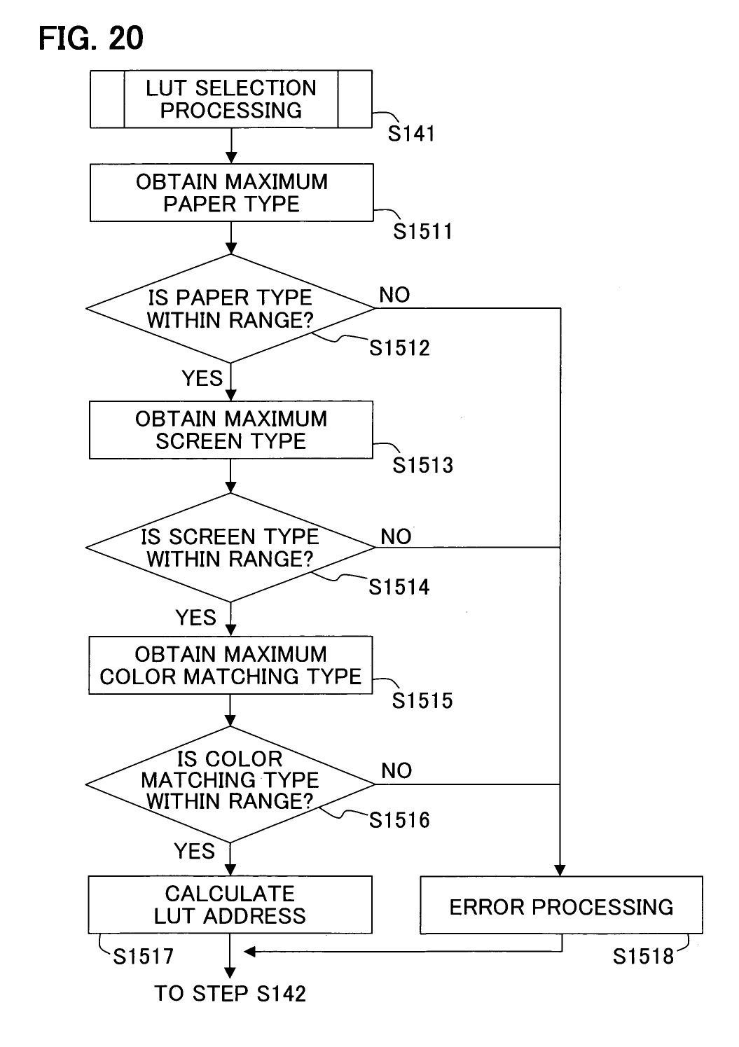

Next, the CPU 20 advances to color conversion processing (step S14), in which the LUT selection processing shown in FIG. 13 is performed (step S141). In this LUT selection processing, the maximum value stored in the table data portion 237 is used, and therefore the processing shown in FIG. 20 is performed instead of the processing shown in FIG. 14.

First, the CPU 20 reads the maximum paper type value from the table data portion 237 of the program ROM 23 (step S1511) Next, the read value is compared with the paper type information from the host 1 side, obtained during the language processing (step S13) performed by the language module 233, and a determination is made as to whether or not the read value is within the range of the maximum value (step S1512). If “5” is stored as the maximum paper type value, for example, and the obtained paper type is “1” (normal paper), then the obtained value is determined to be within range (“YES” in the step S1512). If the specified paper type is “6” (glossy paper), then the obtained value is determined to be out of range (“NO”). When the obtained value is within range, the CPU 20 then obtains the maximum screen type value from the table data portion 237 (step S1513) The read maximum value is then compared with the screen information from the host 1 side, obtained during the language processing performed by the language module 233 (step S1514). If “5” is stored as the maximum value, for example, and the obtained screen type is “2” (gradation priority), then the obtained value is determined to be within range (“YES” in the step S1514). If not, then the obtained value is determined to be out of range (“NO”).

When the screen type is also within range, the CPU 20 then obtains the maximum color matching type value from the table data portion 237 (step S1515). Next, the CPU 20 compares the obtained value with the color matching type information from the host 1 side, obtained during the language processing (step S1516). If the maximum value is “5”, for example, and the obtained information is “1” (natural color), then the obtained information is within range (“YES”), and if not, then the obtained information is determined to be out of range (“NO”).

If the color matching type is also within range, then the three parameters are in a state whereby a single LUT table can be selected from the table data portion 237. The CPU 20 then performs address calculation in order to select a LUT table (step S1517). The calculation method uses the Equation (1) in the step S1414 (see FIG. 14) of the first embodiment. When the calculation is complete, the LUT selection processing (step S141) ends.

If, on the other hand, any of the paper type, screen type, and color matching type are outside the maximum value range stored in the table data portion 237 (“NO” in the steps S1512, S1514, S1516), similar error processing to that of the selection processing shown in FIG. 14 is performed (step S1518). For example, a message indicating that a selection cannot be made is displayed on the display portion 27, or a default LUT table is selected. When the error processing is complete, the LUT selection processing (step S141) ends.

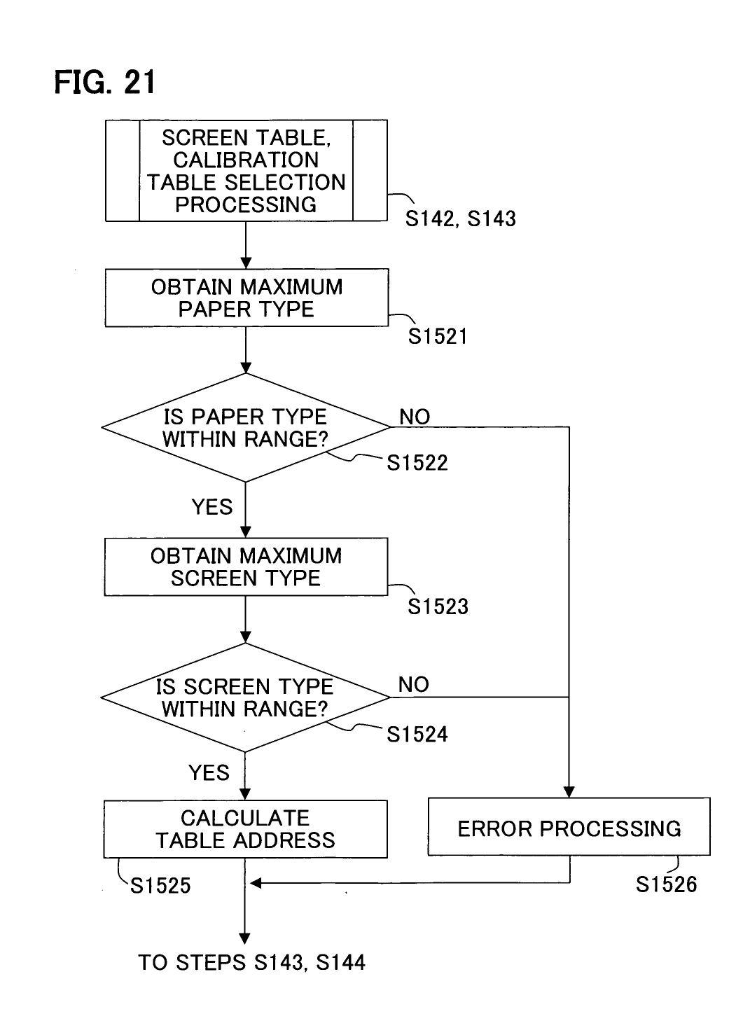

Returning to FIG. 13, following the LUT selection processing, calibration selection processing is performed (step S142). This processing also uses the maximum value stored in the table data portion 237 of the program ROM 23, and hence differs from the processing of the first embodiment. The processing is shown in detail in FIG. 21.

Each process is substantially identical to those in FIG. 20. Calibration processing is performed after color conversion, and therefore information about the color matching type is not required for table selection. First, the maximum paper type value is read from the table data portion 237 (step S1521), and then compared with the paper type information specified on the host 1 side during the language processing (step S13) performed by the language module 233 (step S1522). If the obtained paper type information is within the range of the maximum value (“YES” in the step S1522), the CPU 20 then reads the maximum screen type from the table data portion 237 (step S1523) and compares the maximum screen type with the screen type information obtained during language processing (step S1524). If the obtained screen type information is within the range of the maximum value (“YES” in the step S1524), the CPU 20 performs address calculation of the calibration table, and thereby selects a table (step S1525). The Equation (2) of the first embodiment is used to calculate the address. If any of the values are out of range (“NO” in the steps S1522 and S1524), error processing is performed by displaying a message indicating that the values are out of range or the like (step S1526).

Returning to FIG. 13, next screen table selection processing (step S143) is performed. The content of this processing is identical to that of calibration selection processing (see FIG. 21). The maximum paper type and screen type values are read from the table data portion 237 of the program ROM 23, and compared with the information obtained during language processing (step S13). If all of the values are within range (“YES” in the steps S1522 and S1524), address calculation is performed, whereby a screen table is selected (step S1525). If either of the values are out of range (“NO” in the steps S1522, S1524), error processing is performed (step S1526). The screen table selection processing (step S143) then ends. Note that these table selection processes (steps S141 through S143) may be performed in any order.

The selected LUT table 237d is then used to perform color conversion processing (step S144 in FIG. 13). The color-converted CMYK image data are then expanded into the band memory by the band creation module 235 (step S15, see FIGS. 7 and 16), whereupon print processing (step S16) is performed by the printing module 236. During print processing, the selected calibration table and screen table are used to perform calibration processing (step S161 in FIG. 17) and screen processing (step S162) respectively. A printing operation is then performed in the print engine 26 via pulse width modification processing. If further print data exist, the aforementioned processes are repeated (“NO” in the step S17 of FIG. 7), and if there are no more print data (“YES”), the power is switched off and the series of processes comes to an end.

As described above, in the second embodiment maximum values of the parameters required to select the various tables are stored in the rewritable storage area, and hence erroneous table selection caused by position deviation on the table matrices can be prevented. Moreover, by storing the maximum values in the rewritable area, individual user response can be realized when the user wishes to increase the number of paper types, color matching types, and screen types, for example. Furthermore, since there is no need to recreate the program ROM 23, the wasteful labor involved therein can be avoided, and hence user-friendliness is enhanced. Further, by outputting the maximum parameter values stored in the table data portion 237 to the host computer 1 side for display on a monitor or the like, not shown in the drawings, the user becomes less likely to select a higher parameter than the maximum value, and therefore the table requested by the user can be selected reliably.

### Third Embodiment

Next, address management of the table data portion 237 will be described. The constitution of the table data portion 237 was described using FIGS. 4 and 19, but in actuality, the LUT table 237d, screen table 237e, and calibration table 237f are constituted by the area in which each table is stored, and an address value indicating that area.

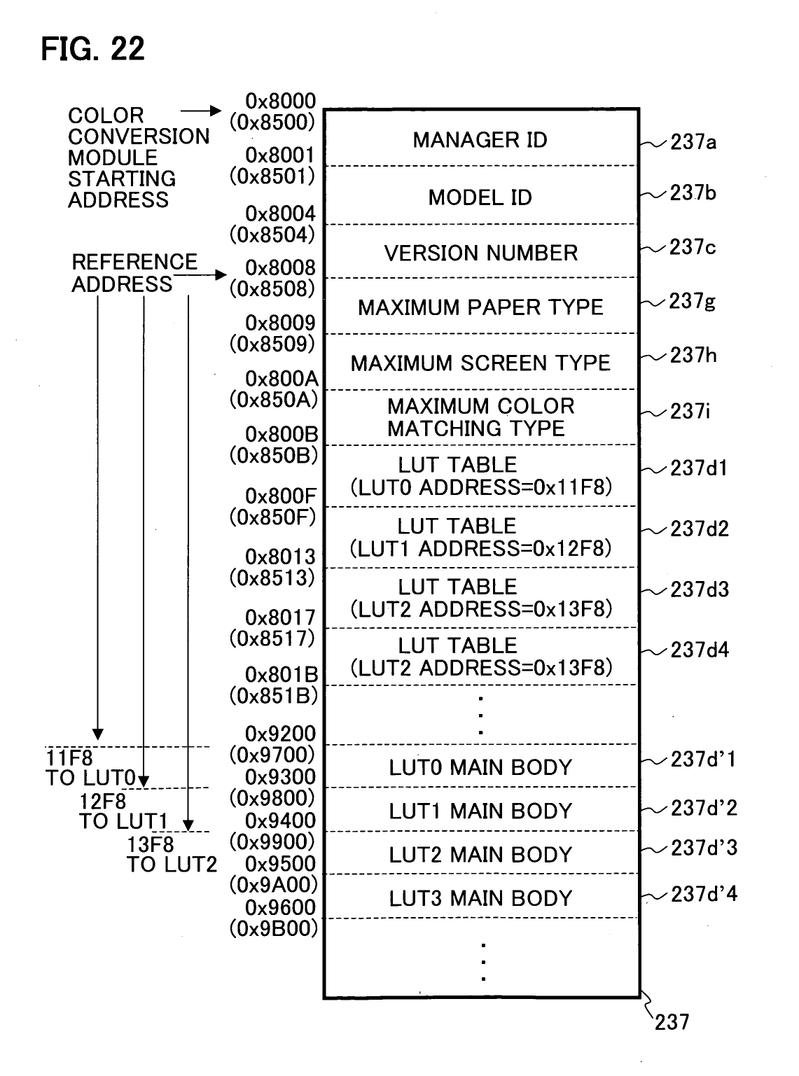

A specific example of the constitution of the table data portion 237 is shown in FIG. 22. In the case of the LUT table 237d, the main bodies of the LUT tables themselves are stored in LUT main body areas 237d′1, 237d′2, . . . , and the address values of each stored LUT main body are stored in LUT table areas 237d1, 237d2, . . . . In this embodiment, a distance from a reference address (a relative address value) is stored in the LUT table areas 237d1, 237d2, . . . rather than the address value at which the table main body is stored. As a result, for example when the table data portion 237 itself is stored in a different storage medium to the program ROM 23, for example the NVRAM 24 or an external ROM, such that the first address of the table data portion 237 (here, the manager ID area 237a) changes and the address values are modified in succession, each of the table main bodies can still be accessed.

This will be described in detail using FIG. 22. The manager ID 237a, model ID 237b, version number 237c, maximum paper type 237g, maximum screen type 237h, and maximum color matching type 237i were described in the first and second embodiments, and therefore further description thereof has been omitted. As shown in FIG. 22, the LUT table 237d is constituted by the LUT table areas 237d1, 237d2, . . . , in which the relative address of each table main body is stored, and the LUT main body areas 237d′1, 237d′2, . . . , in which the LUT main bodies themselves are stored. The LUT table areas 237d1, 237d2, . . . exist in a number corresponding to the number of squares on the matrices shown in FIGS. 5 and 18. In the example in FIG. 5, there are four paper types, five screen types, and five color matching types, and therefore in this case, a total of 100 (4×5×5) LUT table areas 237d1, . . . exist.

In this case, relative address values are stored in the LUT table areas 237d1, . . . , and the first starting address of the table portion (see FIG. 4), excluding the header, serves as a reference, as shown in FIG. 22, for example. When the starting address of the area for storing the maximum paper type 237g is set as the reference address, the address thereof is “0x8008”, and the starting address of the area 237d′1 for storing the LUT0 (the “0th” LUT table) main body is “0x9200”. Since the distance is “0x11F8”, then “0x11F8” is stored in the LUT table area 237d1 which stores the address value of the LUT0 table. Likewise, “0x12F8” is stored in the LUT table area 237d2, and “0x13F8” is stored in the LUT table area 237d3.

By storing a relative address value from the reference address in the LUT table areas 237d1, . . . in this manner, the LUT main body areas 237d′1, . . . can be accessed even when the table data portion 237 is stored in a different area of or a different storage medium to the program ROM 23, for example.

A case in which the address values are modified, as shown in parentheses in FIG. 22, will now be considered. When the starting address of the table data portion 237 is modified from “0x8000” to “0x8500”, the address of the LUT0 main body area 237d′1 for storing the LUT0 table is modified from “0x9200” to “0x9700”. If the address value of the LUT0 main body area 237d′1 is stored as is in the LUT table area 237d1, the address value stored in the area 237d1 must be modified in accordance with the prior modification. This modification places a heavy burden on the user. If the relative address from the reference address is stored, a modified address value of “0x9700” can be obtained by adding the relative address “0x11F8” to the modified reference address “0x8508”. Likewise, the LUT main body area 237d′2 may be accessed simply by adding the relative address value.

The screen table 237e and calibration table 237f are constituted similarly by areas in which a relative address from a reference address is stored, and areas in which the actual screen tables and calibration tables are stored, although these are not shown in FIG. 22. By storing the relative address, each table can be accessed in an identical manner even when the table data portion 237 is stored in a different area.

In the example in FIG. 22, the top of the table (the top of the area in which the maximum paper type 237g is stored), excluding the header, is set as the reference address, but the starting address of the table data portion 237 (the starting address of the area in which the manager ID area 237a is stored), or the starting address of the LUT table area 237d0, for example, may be used instead.

By storing the relative address in this manner, each table main body may be accessed without rewriting the address, even when the table data portion 237 is stored on another storage medium or used in another system, and hence color conversion, screen processing, and calibration processing can be performed. Moreover, there is no need to modify the color conversion module 234 itself, and hence no burden is placed on the user. Accordingly, color conversion processing, calibration processing, and screen processing can be performed without the need to rewrite the addresses, even when the table data portion 237 is transplanted to another system, and hence user-friendliness is enhanced.

### Fourth Embodiment

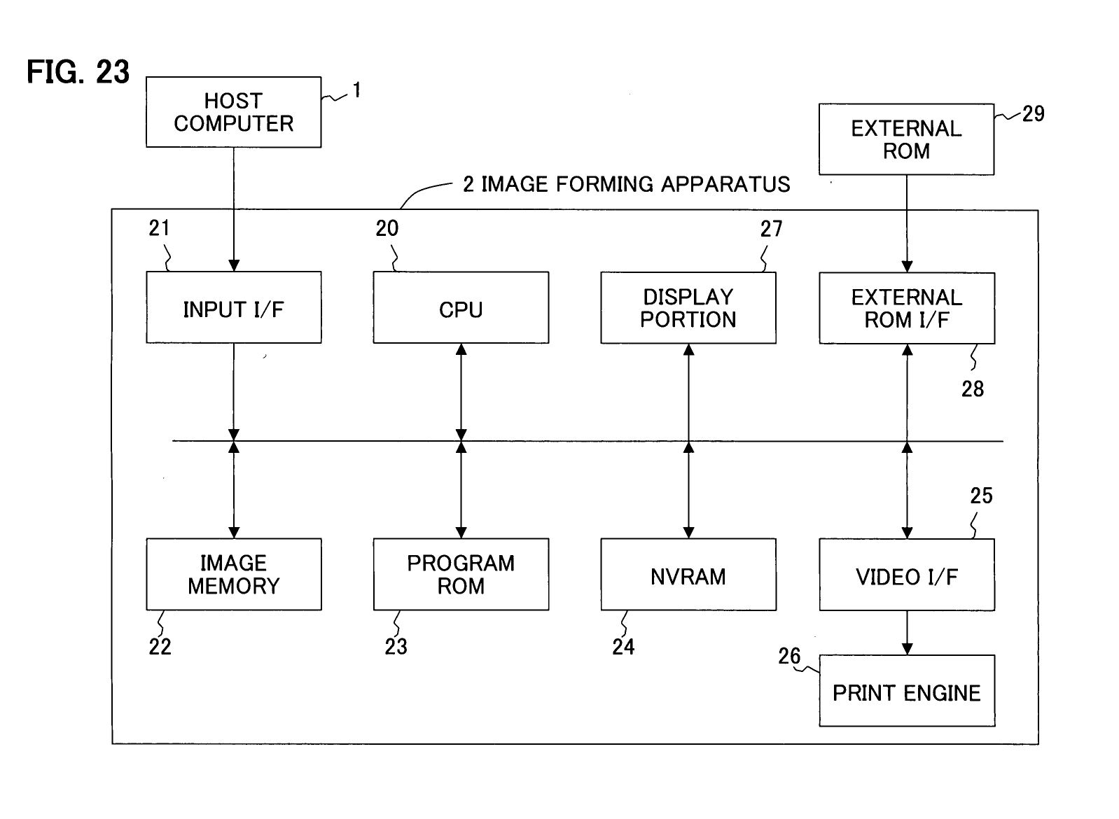

In the example described above, the data processing portion 237 of the color conversion module is stored in the rewritable area of the program ROM 23 or the NVRAM 24, but the data processing portion 237 may also be stored in a rewritable external ROM 29, as shown in FIG. 23. In this case, the image forming apparatus 2 is provided with an external ROM interface (I/F) 28, and the processing described above can be performed by having the CPU 20 read the table data 237 when the external ROM 29 is loaded into the image forming apparatus 2. As described in the third embodiment, if a relative address from a reference address is stored in relation to the areas for storing the table main bodies in this case also, the tables can be read and processing such as color conversion can be performed without the need to correct the addresses, even when the table data in the external ROM 29 are copied to the program ROM 23, for example.

Further, in the three embodiments described above, a laser printer is used as an example of the image forming apparatus 2, but the present invention may also be applied to an ink jet printer or Bubble Jet (registered trademark) printer, which performs printing by discharging ink onto a printing medium from a head charged with ink of various colors. As well as a printer, the present invention may also be applied to a copier or facsimile, or to a compound machine comprising the functions thereof, thereby obtaining the same effects.

Further, a personal computer may be cited as a typical example of the host computer 1, but an information carrying terminal such as a portable telephone or PDA (Personal Digital Assistance) may also be used.

1. An image forming apparatus in which a modularized program is stored, for forming an image on the basis of said program, comprising:
rewritable storage unit for storing table data required when a color conversion module of said program is to be executed; and
control unit for reading said table data from said storage unit when said color conversion module is to be executed using said table data, and executing said color conversion module.

2. The image forming apparatus according to claim 1, wherein said table data include color conversion table data for converting RGB image data into CMYK image data, and said color conversion module includes a module for performing color conversion processing through said control unit using said color conversion table data.

3. The image forming apparatus according to claim 1, wherein said table data include a calibration table for modifying an engine characteristic, and said color conversion module includes a module for performing calibration processing through said control unit using said calibration table.

4. The image forming apparatus according to claim 1, wherein said table data include a screen table for generating dot data expressing a halftone of a grayscale image, and said color conversion module includes a module for performing screen processing through said control unit.

5. The image forming apparatus according to claim 1, wherein said storage unit is a different medium to a storage medium in which said program is stored.

6. The image forming apparatus according to claim 5, wherein said storage unit is an external storage medium that can be loaded into said image forming apparatus.

7. The image forming apparatus according to claim 1, wherein said control unit select any one of said table data from a combination of at least two of a paper type, a color matching type, and a screen type, and execute said color conversion module on the basis of said selected table data.

8. A storage medium for storing a modularized program, which is read by said image forming apparatus, thereby forming an image, comprising:
rewritable area for storing table data required when a color conversion module of said program is to be executed, and wherein
when said color conversion module is to be executed in said image forming apparatus using said table data, said color conversion module is executed by reading said table data from said rewritable area.
